(19) United States
(12) Patent Application Publication
(10) Pub. No.: US 2007/0247283 A1
(43) Pub. Date: Oct. 25, 2007

(54) Method for Manufacturing a Communication Device of a Radio Frequency Identification System and Related Apparatus

(76) Inventors: Chuan-Yi Lee, Taoyuan County (TW); Jian-Chin Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/383,492

(22) Filed: May 16, 2006

(30) Foreign Application Priority Data
Mar. 30, 2006 (TW) 095111292

(51) Int. Cl. H04Q 5/22

(52) U.S. Cl. 340/10.1; 340/572.8; 29/825

(57) ABSTRACT

A method for manufacturing a communication device of a radio frequency identification system forms a base board, forms a signal processing circuit, forms a resonance circuit on the base board, and forms a metal coupler matching the resonance circuit between the signal processing circuit and the resonance circuit on the base board.

### BACKGROUND OF THE INVENTION

1. Field of the Invention

The present invention provides a method for manufacturing a communication device of a radio frequency identification system and related apparatus, and more particularly, a method for forming a resonance circuit and a metal coupler matching the resonance circuit on the same base board, so as to prevent receiving influence from the environment and fabrication, and to effectively transmit signal power from a signal processing circuit to the resonance circuit with the metal coupler.

2. Description of the Prior Art

In daily life, people often use a variety of digital identification (ID) cards, such as credit cards, phone cards, ATM cards, and entrance cards. Most of the digital ID cards have contacts or magnetic bars for exchanging signals with card readers, which may be worn or torn with the result that the cards lose efficacy after long-term use. Moreover, the cards must be read in a specified direction, and failure may result if read in a wrong direction.

A radio frequency identification system, or RFID system, transmits digital data through a radio frequency channel, such that an RFID reader contactlessly reads or writes data to an RFID card. Therefore, there is no specified direction to be obeyed as the RFID reader reads the RFID card, and the RFID card can be read even if it is stored in one's pocket or wallet, which increase convenience greatly.

The RFID system is composed of a tag, a reader, and an application system. The tag is a transponder, including chips for performing analog and digital signal processing, and an antenna designed according to a work frequency and the environment. The reader comprises an analog control unit, a digital control unit, a micro processing unit, and a reading antenna. The application system is a middleware, utilized for controlling the reader to retrieve information stored in the tag.

In the RFID system, in order to increase coupling efficiency and decrease attenuation, the antennas of the reader and the tag are parallel or serial resonators. Take the parallel resonator for example. Please refer to FIG. 1, which illustrates a schematic diagram of a prior are RFID system 10. The RFID system 10 includes a reader 100 and a tag 102. The reader 100 and the tag 102 include parallel resonance circuits 108 and 106 respectively. The reader 100 and the tag 102 are magnetically coupled together through an alternating-current magnetic field built with the resonance circuits 108 and 106. Such magnetic coupling between the reader 100 and the tag 102 induces electromotive force in the tag 102, and generates work current after rectifying and filtering by a diode and a capacitor. Then, a two-way communication is established between the reader 100 and the tag 102.

In the reader 100, a metal coupler 104 transmits signals outputted from a variable gain amplifier to the resonance circuit 108, or separates signals received by the resonance circuit 108 to a frequency mixer. That is, the metal coupler 104 is a signal route between a transceiver end and a signal-processing end of the reader 100. To work correctly, the resonance circuits 108 and 106 must be resonated around a specified frequency, such as 13.56 MHz. Coupling efficiency of the resonance circuits 108 and 106 are affected by Q values. A resonance circuit with a large Q value has high coupling efficiency, and can generate electromagnetic field with small power. Therefore, the Q value of the resonance circuit 108 is large in the prior art. However, the resonance circuit with the large Q is easily affected by the environment, has a narrow bandwidth, and must be fine tuned when manufacturing, so that the resonance circuit 108 must be fine tuned to compensate frequency shifts caused by neighboring metal units after being installed on a PCB.

The prior art installs the resonance circuit 108 and the metal coupler 104 by two methods as follows. First, the resonance circuit 108 is formed on a system circuit board of the reader 100, and is then connected to the metal coupler 104. Second, the resonance circuit 108 is formed on an independent circuit board, and is then connected to the metal coupler 104. The first method may be easily affected by the environment and fabrication, and thus decreases efficiency. The second method can improve the first method, but there may be power dissipation between the resonance circuit 108 and the metal coupler 104. Therefore, how to install the resonance circuit 108 and the metal coupler 104 becomes an objective in industry.

### SUMMARY OF THE INVENTION

It is therefore a primary objective of the claimed invention to provide a method for manufacturing a communication device of a radio frequency identification system and related apparatus.

According to the claimed invention, a method for manufacturing a communication device of a radio frequency identification system forms a base board, forms a signal processing circuit, forms a resonance circuit on the base board, and forms a metal coupler matching the resonance circuit between the signal processing circuit and the resonance circuit on the base board.

According to the claimed invention, a communication device of a radio frequency identification system comprises a base board, a signal processing circuit for processing signals, a resonance circuit formed on the base board for generating resonance signals or sensing resonance signals, and a metal coupler matching the resonance circuit between the signal processing circuit and the resonance circuit on the base board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior are RFID system.

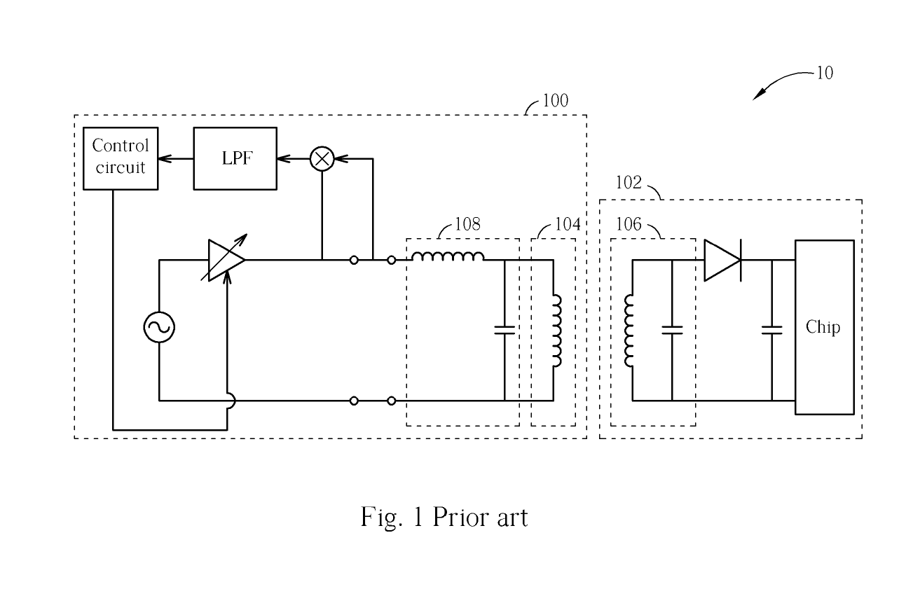

FIG. 2 illustrates a flowchart of a process for manufacturing a communication device of an RFID system in accordance with the present invention.

FIG. 3 illustrates a schematic diagram of a communication device of an RFID system in accordance with the present invention.

### DETAILED DESCRIPTION

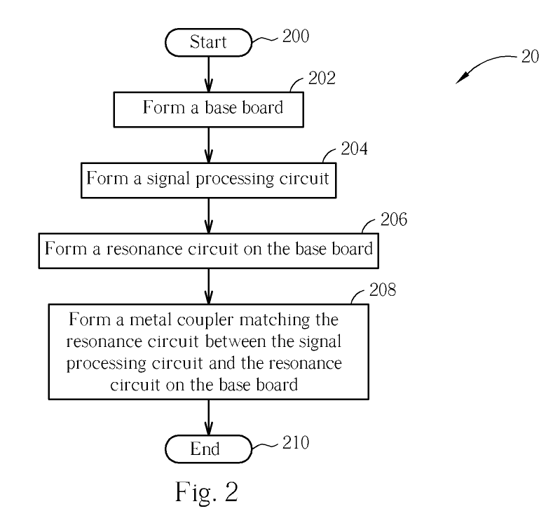

Please refer to FIG. 2, which illustrates a flowchart of a process 20 for manufacturing a communication device of an RFID system in accordance with the present invention. The process 20 includes the following steps:

Step 200: start.

Step 202: form a base board.

Step 204: form a signal processing circuit.

Step 206: form a resonance circuit on the base board.

Step 208: form a metal coupler matching the resonance circuit between the signal processing circuit and the resonance circuit on the base board.

Step 210: end.

According the process 20, the present invention forms both the resonance circuit and the metal coupler matching the resonance circuit on the same base board, so as to decrease influence of the environment and fabrication, and to effectively transmit signal power from the signal processing circuit to the resonance circuit with the metal coupler. Preferably, the metal coupler is an equivalent circuit including capacitors, inductors, and resistors in parallel connection. A designer can adjust characteristics of the units (capacitors, inductors, and resistors) of the metal coupler to compensate resonance frequency shifts of the resonance circuit, which are caused by neighboring metals or circuit blemishes. That is, since the resonance circuit with a large Q value must be fine tuned when manufacturing, the present invention fine tunes the resonance by adjusting the characteristics of the units of the metal coupler. In other words, the present invention adjust the characteristics of the units of the metal coupler according to a predetermined resonance frequency (13.56 MHz), a shape, etc. of the resonance circuit, so as to fine tune the resonance frequency generated by the resonance circuit. The metal coupler is an equivalent circuit including capacitors, inductors, and resistors in parallel connection, so it is easy to adjust the characteristics of the units of the metal coupler.

Forming both the resonance circuit and the metal coupler matching the resonance circuit on the same base board, the present invention can increase production efficiency of the RFID system, and prevent being affected by the environment and fabrication, so that signal power of the signal processing circuit can be efficiently transmitted to the resonance circuit with the metal coupler. Preferably, the signal processing circuit is also formed on the base board, the base board is a printed circuit board, and the communication device can be a reader or a tag of the RFID system.

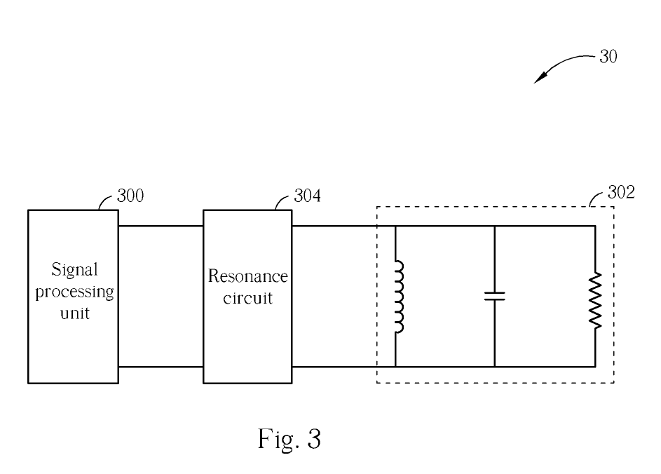

Please refer to FIG. 3, which illustrates a schematic diagram of a communication device 30 of an RFID system in accordance with the present invention. The communication device 30 includes a signal processing circuit 300, a metal coupler 302, and a resonance circuit 304. The metal coupler 302 and the resonance circuit 304 are formed in the same base board (not shown in FIG. 3), and preferably, the signal processing circuit 300 is also formed on the base board. The base board is a printed circuit board. The signal processing circuit 300 radios signals or inducts signals through the resonance circuit 304. The metal coupler 302 is an equivalent circuit including capacitors, inductors, and resistors in parallel connection, and matches the resonance circuit 304, utilized for compensating frequency shifts of the resonance circuit 304. Therefore, a designer can adjust characteristics of the units (capacitors, inductors, and resistors) of the metal coupler 302 to compensate resonance frequency shifts of the resonance circuit 304, which are caused by neighboring metals or circuit blemishes.

In summary, the present invention forms the resonance circuit and the metal coupler matching the resonance circuit on the same base board, so as to prevent from being influenced by the environment and fabrication, and to effectively transmit signal power from the signal processing circuit to the resonance circuit with the metal coupler. Moreover, the present invention adjusts the characteristics of the units of the metal coupler according to a predetermined resonance frequency and a shape of the resonance circuit, so as to fine tune the resonance frequency generated by the resonance circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for manufacturing a communication device of a radio frequency identification system comprising:
forming a base board;
forming a signal processing circuit;
forming a resonance circuit on the base board; and
forming a metal coupler matching the resonance circuit between the signal processing circuit and the resonance circuit on the base board.

2. The method of claim 1, wherein the signal processing circuit is formed on the base board.

3. The method of claim 1 further comprising adjusting characteristics of the metal coupler according to an operating frequency of the resonance circuit.

4. The method of claim 3, wherein the operating frequency is about 13.56 MHz.

5. The method of claim 1 further comprising adjusting characteristics of the metal coupler according to a shape of the resonance circuit.

6. The method of claim 1, wherein forming a metal coupler matching the resonance circuit between the signal processing circuit and the resonance circuit on the base board comprises forming an equivalent circuit comprising a capacitor, an inductor, and a resistor between the resonance circuit and the signal processing circuit.

7. The method of claim 1, wherein the base board is a printed circuit board.

8. A communication device of a radio frequency identification system comprising:
a base board;
a signal processing circuit for processing signals;
a resonance circuit formed on the base board for generating resonance signals or sensing resonance signals; and
a metal coupler matching the resonance circuit between the signal processing circuit and the resonance circuit on the base board.

9. The communication device of claim 8, wherein the signal processing circuit is formed on the base board.

10. The communication device of claim 8, wherein the metal coupler comprises:
a capacitor;
a inductor parallel to the capacitor; and
a resistor parallel to the capacitor and the inductor.

11. The communication device of claim 10, wherein capacitance of the capacitor, inductance of the inductor, and resistance of the resistor are adjusted according to an operating frequency of the resonance circuit.

12. The communication device of claim 11, wherein the operating frequency is about 13.56 MHz.

13. The communication device of claim 10, wherein capacitance of the capacitor, inductance of the inductor, and resistance of the resistor are adjusted according to a shape of the resonance circuit.

14. The communication device of claim 8, wherein the base board is a printed circuit board.
